(19) United States
(12) Patent Application Publication
(10) Pub. No.: US 2005/0137020 A1
(43) Pub. Date: Jun. 23, 2005

(54) Controlled collapsible drive line arrangement

(76) Inventors: Brian E. Beechie, Armada, MI (US); Klaus Niehaus, Northville, MI (US); Dietmar Fischer, Plymouth, MI (US); Robert Turkovich, Farmington Hills, MI (US); Thomas S. Kaliszewski, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/738,849

(22) Filed: Dec. 17, 2003

(51) Int. Cl. F16D 9/00

(52) U.S. Cl. 464/32

(57) ABSTRACT

A collapsible torque transfer shaft arrangement for a motor vehicle powertrain is provided. The collapsible shaft arrangement includes an axially translatable coupling mechanism that allows drive line drive shaft members to telescopically collapse while maintaining a non-rotateable connection among the respective drive shaft members. The coupling mechanism also includes a locking pin arranged in the coupling mechanism such that axial connectivity of the respective drive shaft members is maintained below a predetermined force threshold irrespective of other drive line power train components.

### FIELD OF THE INVENTION

The present invention relates generally to drive shafts for a motor vehicle, and, more particularly, to an improved collapsible drive shaft arrangement for a motor vehicle powertrain.

### BACKGROUND OF THE INVENTION

Generally, drive lines in vehicle powertrains are used to connect a transmission output to a torque distribution mechanism for transmitting torque to drive wheels of a motor vehicle. The drive lines are typically rigid with universal joint (U-joint) connections as is known in the art. It is also known where a drive line has been configured in a collapsible arrangement with the drive line including two collapsible shafts that are free to slide axially relative to each other.

While such systems provide advantages because they are collapsible, the drive shafts of these known arrangements rely on drive line connective restraints, such as static elements, to maintain position relative to each other.

### SUMMARY OF THE INVENTION

Accordingly, an improved collapsible drive shaft arrangement is provided which is able to maintain within a desired force range, the connectivity of drive line drive shaft components irrespective of other drive line powertrain components.

In accordance with one aspect of the present invention, a drive line is provided that includes an axially translatable coupling mechanism and first and second drive shafts. The first drive shaft is coupled to transmission and the second drive shaft is coupled to a torque distribution mechanism for distributing torque to vehicle drive wheels. The axially translatable coupling mechanism slideably couples the first and second drive shafts in an axial direction while also providing a non-rotateable connection between the drive shafts. A pin member is positioned in the axially translatable coupling mechanism and includes a predetermined shear threshold that is arranged to control the force range for which the coupling mechanism allows the drive shafts to collapse axially with respect to each other.

### BRIEF DESCRIPTION OF THE DRAWINGS

Other aspects, features, and advantages of the present invention will become more fully apparent from the following detailed description of the preferred embodiment, the appended claims, and in the accompanying drawings in which:

FIG. 1 illustrates a side view of a drive line assembly including a controlled collapsible drive line arrangement in accordance with the present invention;

FIG. 2 illustrates an expanded view of a controlled collapsible coupling mechanism illustrated in FIG. 1 in accordance with the present invention; and

FIG. 3 illustrates an expanded view of components of the controlled collapsible drive line assembly in a pre-assembled state in accordance with the present invention.

### DETAILED DESCRIPTION OF THE PREFERRED EMBODIMIENT

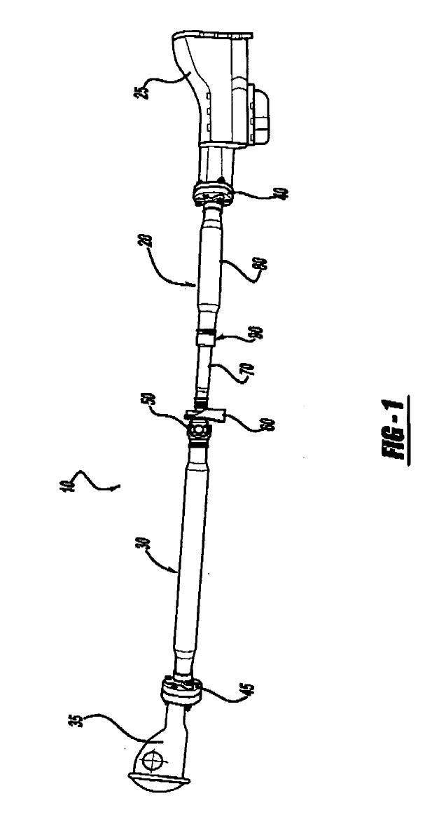

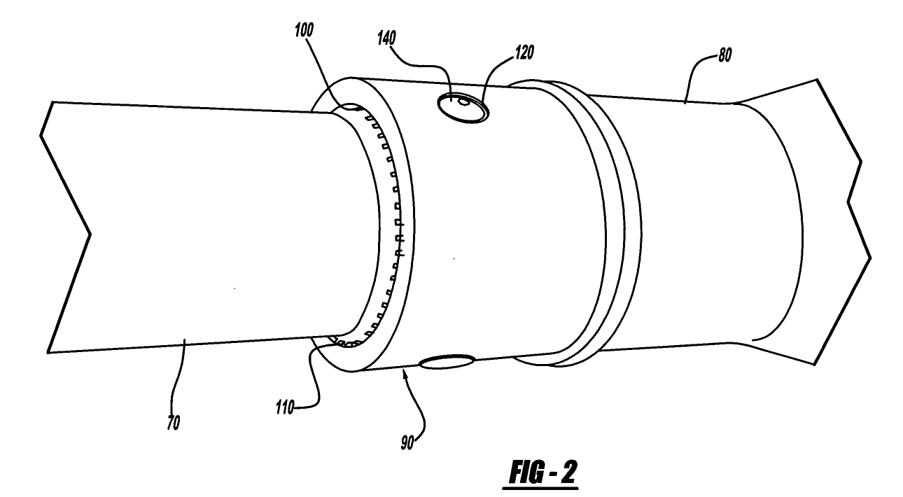

Referring now to the drawings, FIGS. 1 and 2 illustrate an exemplary embodiment of a drive line assembly 10 with a controlled collapsible drive line arrangement in accordance with the present invention. The drive line assembly includes a first shaft section 20 and a second shaft section 30. The first shaft 20 section is connected to a transmission at one end through a flexible coupling 40 and is also connected at another end to the second shaft section 30 by a U-joint 50. The second shaft section 30 is connected to a differential through flexible coupling 45. The drive line assembly 10 further includes a support 60 which is attached to a vehicle structural member (not shown).

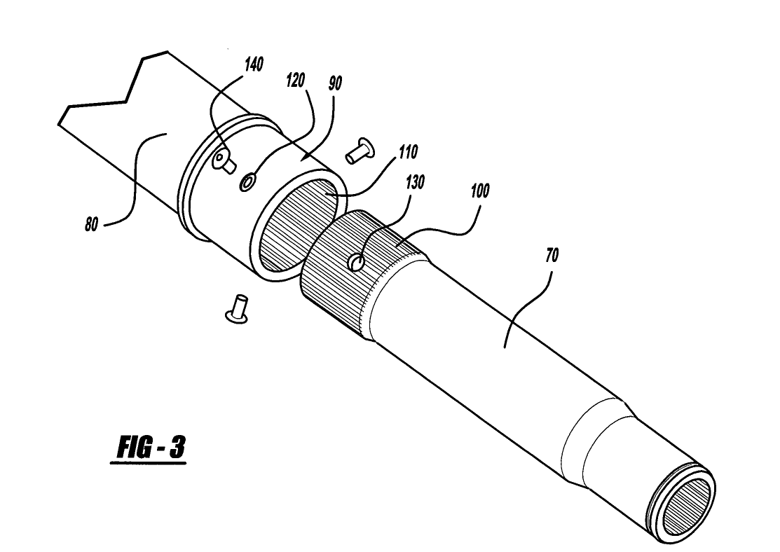

The first shaft section 20 further includes a first shaft member 70 and a second shaft member 80. The first and second shaft members are coupled together though an axially translatable coupling mechanism 90. As best seen in FIG. 3, the coupling mechanism 90 includes internal splines 100 extending radially inwardly towards the center of the coupling mechanism 90. The splines 100 mesh with external splines 110 that extend radially outwardly from first shaft member 70.

The coupling mechanism 90 further includes a bore 120 that coincides with a mating bore 130 in the splined portion of the first shaft section 70 upon assembly as shown in FIG. 3. A shear pin member 140 is inserted into coinciding bores 120 and 130 in the assembled shaft members 70 and 80 as shown in FIGS. 2 and 3. In the preferred embodiment, shear pin member 140 is assembled into coinciding bores 120 and 130 in a press fit or rivet configuration.

In operation, the controlled collapsible shaft arrangement provides for a drive line assembly that includes a coupling arrangement which allows for controlled collapsibility in the axial direction among respective drive shaft members while maintaining a non-rotateable connection among the same respective drive shaft members. More specifically, the splines of drive shaft members 70 and 80 allow for a non-rotateable connection among shaft members 70 and 80 while also providing for an axially translatable coupling arrangement. The shear pin or rivet inserted into coinciding bores of shaft members 70 and 80 further provides for controlled axial translation or collapsibility among shaft members 70 and 80. It should be appreciated that the shear pin can be constructed so as to have a predetermined shear threshold thus maintaining axial connectivity of shaft members 70 and 80 below a predetermined axial force while also allowing axial collapsibility if the drive line assembly experiences a force that exceeds the predetermined shear threshold of the shear pin.

Thus, the drive line system with a collapsible arrangement allows for axial movement among drive shaft members during normal operation. To address potential noise, vibration, and harshness (NVH) issues that may result from the relative movement during normal operation, using the shear pin or rivet arrangement in accordance with the teachings of the present invention, eliminates or significantly modifies relative movement among the coupled drive shaft members until a predetermined axial force is experienced.

The foregoing description constitutes the embodiments devised by the inventors for practicing the invention. It is apparent, however, that the invention is susceptible to modification, variation, and change that will become obvious to those skilled in the art. In as much as the foregoing description is intended to enable one skilled in the pertinent art to practice the invention, it should not be construed to be limited thereby but should be construed to include such aforementioned obvious variations and be limited only by the proper scope or fair meaning of the accompanying claims.

1. A collapsible torque transfer shaft arrangement for a motor vehicle powertrain, the shaft arrangement comprising:
a first shaft member coupled to a transmission;
a second shaft member coupled to a torque distribution mechanism for distributing torque to a drive wheel;
an axially translatable coupling mechanism arranged to slideably couple the first and second shaft members in an axial direction such that the shaft members can not rotate relative to each other, and
a pin member positioned in the coupling mechanism and arranged to engage the drive shaft members to allow axial movement of the shaft members relative to each other in response to a predetermined axial force being placed on at least one of the shaft members.

2. The torque transfer shaft arrangement of claim 1, wherein the coupling mechanism is permanently connected to an end of the first shaft member and arranged to couple the first and second shaft members.

3. The torque transfer shaft arrangement of claim 2, wherein the second shaft member has an externally splined portion with splines extending radially outwardly from a central axis and the coupling mechanism has an internally splined portion with splines extending radially inwardly toward a central axis, the coupling mechanism arranged to couple the first and second shaft members in a non-rotateable connection.

4. The torque transfer shaft arrangement of claim 3, wherein in an assembled configuration, the coupling mechanism and the second shaft member have coinciding bores in their respective splined portions, the coinciding bores arranged to receive the pin member in a press-fit configuration.

5. The torque transfer shaft arrangement of claim 1, wherein the pin member further comprises a predetermined shear strength threshold, the pin arranged to shear and allow the drive shafts to telescopically collapse when the pin member is exposed to a force greater than the predetermined shear threshold.

6. The torque transfer shaft of claim 1, wherein the pin member further comprises a shear rivet.
